(19) United States
(12) Patent Application Publication
(10) Pub. No.: US 2013/0181995 A1
(43) Pub. Date: Jul. 18, 2013

(54) HANDWRITTEN CHARACTER FONT LIBRARY

(71) Applicants: Bao-Yao Zhou, Beijing (CN); Rui Liu, Kitchener (CA); Wei-Hong Wang, Kichener (CA)

(72) Inventors: Bao-Yao Zhou, Beijing (CN); Rui Liu, Kitchener (CA); Wei-Hong Wang, Kichener (CA)

(73) Assignee: Hewlett-Packard Developement Company, L.P., Fort Collins, CO (US)

(21) Appl. No.: 13/825,323

(22) PCT Filed: Sep. 21, 2010
(86) PCT No.: PCT/CN2010/077194

§ 371 Date: Mar. 20, 2013

(51) Int. Cl. G06T 11/60

(52) U.S. Cl. CPC G06T 11/60
USPC 345/467

(57) ABSTRACT

Embodiments of the present disclosure may include methods, systems, and machine readable and executable instructions and/or logic. An example method for creating a handwritten character font library can include receiving a set of standard characters to a computing device, and deriving a group of character components from the initial set of characters. A subset of characters is selected from the set of standard characters, the subset collectively including substantially all the group of character components. Handwritten characters corresponding to the subset of characters are received to the computing device, and handwritten character components are extracted from the hand written characters corresponding to the group of character components. A set of handwritten characters is then constructed from the received handwritten characters and/or the handwritten character components.

### BACKGROUND

Nowadays, most people are used to writing documents using a computer since such documents can be communicated electronically. However, computer-generated documents created using standard word processing system fonts do not convey unique personal style, as handwriting might. Many people look for different ways to personalize their interactions with the world. Some believe that a person's handwriting reveals a lot about his or her personality. While a user may select one of many standardized fonts with which to create electronic documents, the individual user's personality has been lost to some extent by the technology that made communications easier and more efficient since a large number of users may use a same font.

Digital image manipulation tools can be used to modify individual characters (e.g., of a known font) to create individual characters that can be used as a new font. According to a previous approach, a handwritten font library can be created by having a user write out each character, which can then be scanned into a digital format, and saved as members of a font library. However, uniquely modifying each character and/or writing and scanning handwritten characters can be a tedious and time consuming endeavor, particularly for those languages having many unique characters. For example, there are more than 6,700 characters used in the Chinese language. Creating a Chinese handwritten font library can also be a high cost task. For example, a personal calligraphy font library was created for Ms. Jinglei Xu, an actress/director famous in China. She spent approximately two months handwriting the more than 6,700 Chinese characters in printed templates for the font. Such an approach is generally impractical and too expensive for most computer users.

### BRIEF DESCRIPTION OF THE DRAWINGS

FIG. 1 illustrates a computing apparatus suitable to creating a handwritten character font library according to embodiments of the present disclosure.

FIG. 2 illustrates a sample of commonly used Chinese character components.

FIG. 3 illustrates a method for creating character-based font library according to embodiments of the present disclosure.

FIG. 4 illustrates a comparison between original and constructed Chinese handwritten characters according to embodiments of the present disclosure.

FIG. 5 illustrates a method for creating a handwritten character font library according to embodiments of the present disclosure.

### DETAILED DESCRIPTION

Embodiments of the present disclosure may include methods, systems, and machine readable and executable instructions and/or logic. An example method for creating a handwritten character font library can include receiving a set of standard characters to a computing device, and deriving a group of character components from the initial set of characters. A subset of characters is selected from the set of standard characters, the subset collectively including substantially all the group of character components. Handwritten characters corresponding to the subset of characters are received to the computing device, and handwritten character components are extracted from the hand written characters corresponding to the group of character components. A set of handwritten characters is then constructed from the received handwritten characters and/or the handwritten character components.

The following specification provides a description of the method and applications, and use of the system and method of the present disclosure. Since many examples can be made without departing from the spirit and scope of the system and method of the present disclosure, this specification merely sets forth some of the many possible embodiment configurations and implementations.

According to embodiments of the present disclosure, documents (e.g., letters, e-mails, diary, blog, magazines, books etc.) can be created, shared, and printed/published in a person's own handwriting using a font including characters mimicking their own handwriting style. A personal handwritten font library is created and stored, for example, as a system font that can be used by a word processing program, an operating system, and/or other executable instructions configured to utilize an available font library.

To reduce the cost, time, and inconvenience, methods of the present disclosure generate characters of a handwritten font library from a subset of the font library character set. Rather than write out and scan in each and every character of a character set for a font library, a user need only write a subset of the character set. From the subset of the character set, character components can be derived. The subset of the character set can be chosen to maximize character component derivation and/or include very common and/or especially distinctive characters. Additional characters, which are not included in the subset of the character set written out and scanned in, can be formed using the character components derived from the characters of the subset. In this manner, all or substantially all characters of a character set can be constructed from the character components derived from a subset of the character set.

Previous approaches to creating a personalized font library in a person's own handwriting was generally implemented by a process to create handwritten fonts that included the following three tasks: (1) write down all characters on paper using a predefined template; (2) scan template papers to convert characters into images; and (3) saved the scanned character images to a font library file (e.g., TrueType format, OpenType format). Once created, the personalized font library could be installed for use by an OS, for example.

However, languages that utilize a large quantity of unique characters, such as Chinese, Japanese, Korean, etc., increases the time and expense in generating a personalized (e.g., handwritten) font library according to previous approaches since each character of a large quantity of characters has to be written, scanned, and saved. Some previous approaches therefore limited the number of characters included in a font character set (e.g., to a small subset of the most commonly used characters) as one solution to the large quantity of characters in some character sets.

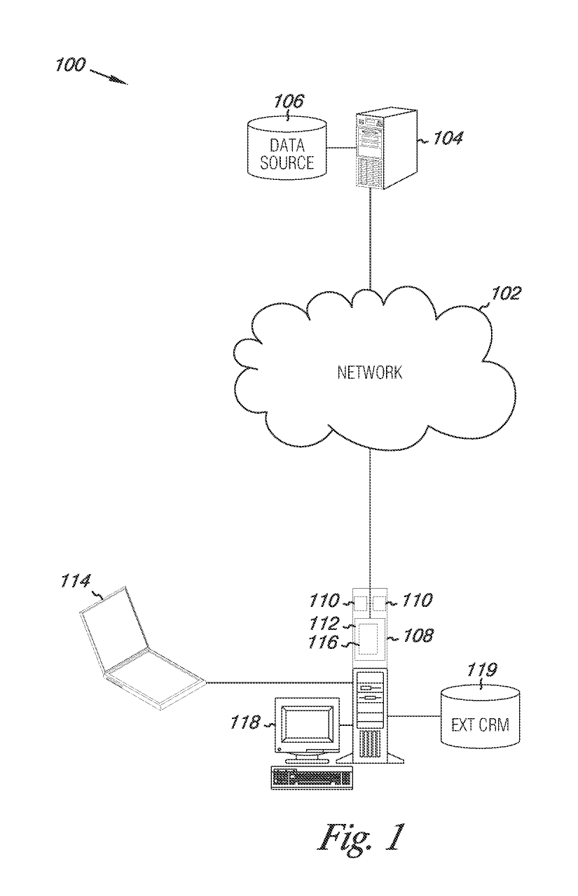

FIG. 1 illustrates a computing apparatus suitable to creating and/or using a handwritten character font library according to embodiments of the present disclosure. The computing system 100 can be comprised of a number of computing resources communicatively coupled to the network 102. FIG. 1 shows a first computing device 104 that may also have an associated data source 106, and may have one or more input/output devices (e.g., keyboard, electronic display). A second computing device 108 is also shown in FIG. 1 being communicatively coupled to the network 102, such that executable instructions may be communicated through the network between the first and second computing devices.

Computing device 108 may include one or more processors 110 communicatively coupled to a non-transitory computer-readable medium 112. The non-transitory computer-readable medium 112 may be structured to store executable instructions 116 (e.g., one or more programs) that can be executed by the one or more processors 110 and/or data. The second computing device 108 may be further communicatively coupled to a production device 118 (e.g., electronic display, printer, etc.) and/or an image scanning apparatus 114. Second computing device 108 can also be communicatively coupled to an external computer-readable memory 119.

The second computing device 108 can cause an output to the production device 118, for example, as a result of executing instructions of one or more programs stored non-transitory computer-readable medium 112, by the at least one processor 110, to implement a handwritten character font library according to the present disclosure. Causing an output can include, but is not limited to, displaying text and images to an electronic display and/or printing text and images to a tangible medium (e.g., paper), in a handwritten font for example. Executable instructions to generate and/or manipulate fonts using handwritten characters may be executed by the first and/or second computing device 108, stored in a database such as may be maintained in external computer-readable memory 119, output to production device 118, and/or printed to a tangible medium.

First 104 and second 108 computing devices are communicatively coupled to one another through the network 102. While the computing system is shown in FIG. 1 as having only two computing devices, the computing system can be comprised of additional multiple interconnected computing devices, such as servers and clients. Each computing device can include control circuitry such as a processor, a state machine, application specific integrated circuit (ASIC), controller, and/or similar machine. As used herein, the indefinite articles “a” and/or “an” can indicate one or more than one of the named object. Thus, for example, “a processor” can include one processor or more than one processor, such as a parallel processing arrangement.

The control circuitry can have a structure that provides a given functionality, and/or execute computer-readable instructions that are stored on a non-transitory computer-readable medium (e.g., 106, 112, 119). The non-transitory computer-readable medium can be integral (e.g., 112), or communicatively coupled (e.g., 106, 119), to the respective computing device (e.g. 104, 108), in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet). The non-transitory computer-readable medium 330 can have computer-readable instructions stored thereon that are executed by the control circuitry (e.g., processor) to provide a particular functionality.

The non-transitory computer-readable medium, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), among others. The non-transitory computer-readable medium can include optical discs, digital video discs (DVD), high definition digital versatile discs (HD DVD), compact discs (CD), laser discs, and magnetic media such as tape drives, floppy discs, and hard drives, solid state media such as flash memory, EEPROM, phase change random access memory (PCRAM), as well as other types of machine-readable media.

The following discussion will illustrate one or more embodiments of the present disclosure as may be applied to the Chinese language. However, embodiments of the present invention are not so limited, and may be applied to other languages and/or character sets.

Chinese characters are structured characters, each of which can consist of one or more character components that can be combined by a variety of different principles (e.g., character components of different sizes, locations within a character, different orientations, etc.). The one or more character components have a specific layout structure. Thus, character components are the most practical structure units of Chinese characters and the building blocks used to construct characters in addition to those from which the character components are derived.

Therefore, it is possible to use a small set of common character components to construct a greater number of Chinese characters. The small set of common character components can usually be found in a subset of all characters. Thus, according to embodiments of the present disclosure, users need only write and input the subset of characters that contains the character components needed to form a desired character set.

For reasons of legibility in recognizing handwritten characters, people usually write Chinese characters with layout structure similar to corresponding standard printed Chinese characters. Although some strokes in handwritten and printed characters can be very different, the layout structures of their character components are usually consistent. In addition, the common character components in different handwritten characters are usually very similar, even though they may be different from those in corresponding printed characters. According to various embodiments of the present disclosure, character components of user's input characters are derived and re-used to construct other characters (e.g., additional characters to those input). For example, it is possible to derive the character components necessary in order to form an entire Chinese handwritten font library from a subset of the entire Chinese character set.

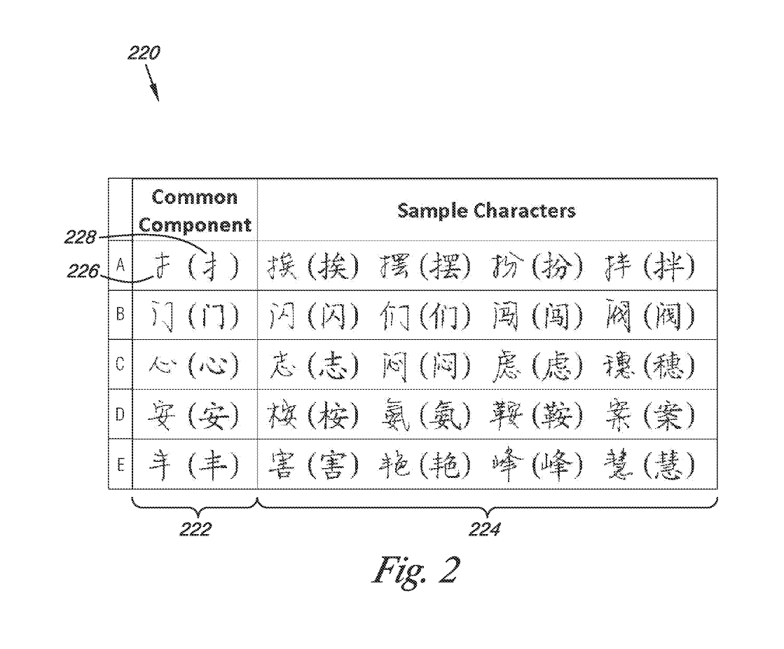

FIG. 2 illustrates a table 220 of commonly used Chinese character components 222 and several examples of sample characters 224 in which a particular character component may be used. Each row (e.g., A, B, C, D, E) corresponds to a particular character component, which is shown in printed character format at 226 and in handwritten format at 228 in the parenthesis. Notice the character component can be used in different positions within the particular sample characters.

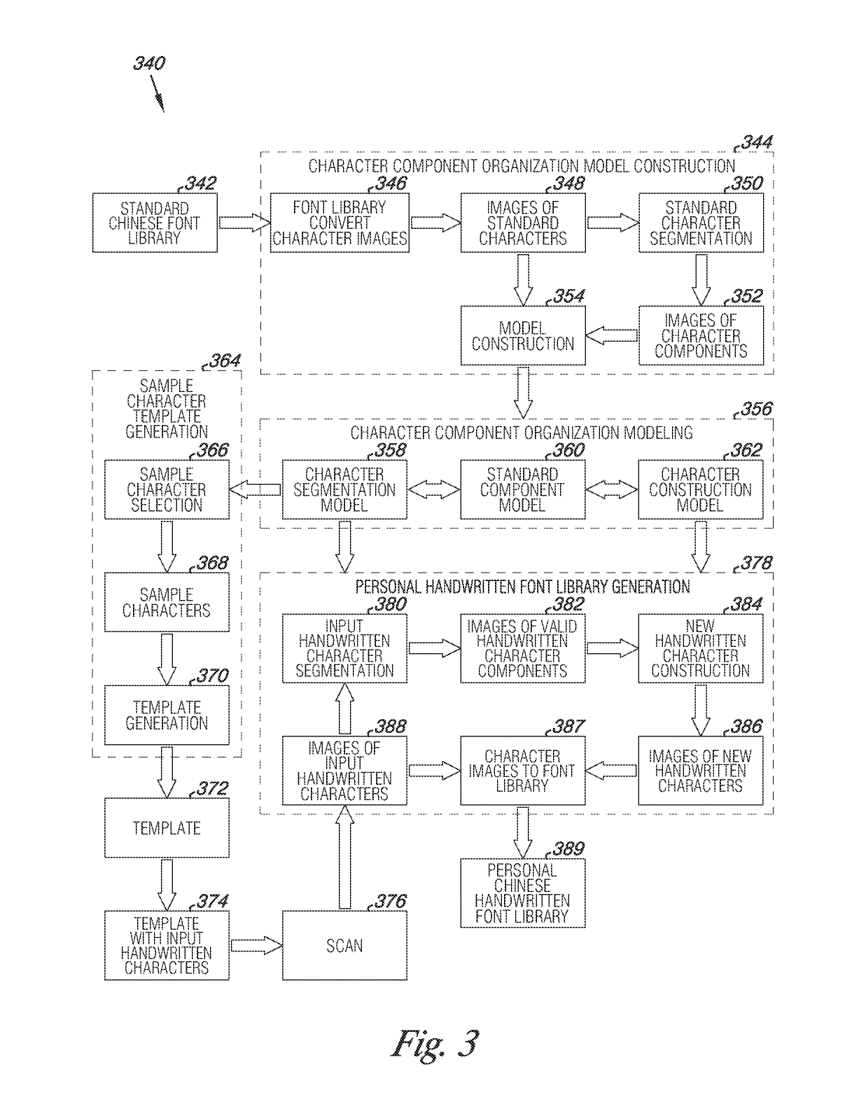

FIG. 3 illustrates a method for creating character-based font library according to embodiments of the present disclosure. The method 340 of the present disclosure for creating a handwritten font library can be organized into several sub-processes: character component organization model construction 344; character component organization modeling 356; sample character template generation 364; and personal handwritten font library generation 378.

According to one or more embodiments of the present disclosure, a standard Chinese font library 342 file can be loaded and converted 346 into a corresponding set of standard character images 348 (e.g., binary bitmap files). The simplified Chinese KaiTi font can be chosen, for example, as the set of standard characters which can be converted into the set of standard character images since it is used most often in modern writings and publications in China.

Each standard character image 348 can be segmented 350 into one or more unconnected character components (e.g., images of character components 352). Standard character segmentation generally involves analyzing each character to derive the respective character components.

A character model can be constructed 354 from the images of standard characters 348 and images of character components 352. For example, a comparison between the character components of multiple characters can determine a set of unique character components that may be scaled and/or re-positioned in particular characters. Character components can be glyphs. Character model construction is based on character components that can be merged as needed level by level to form a character component segmentation hierarchy according to some predefined heuristic rules.

Character component organization modeling develops a model to store the information about how a character is organized by its character components. The organization model can consist of three sub-models: a character construction model 362, a character segmentation model 358, and a standard component model 360. The character construction model 362 can store the organization hierarchy of all character components with their relative size and position associated with each character. A character segmentation model 358 can store the position of separators between dividable character components associated with each character. In the Chinese language, a separator can be a horizontal/vertical rectangle or a rectangular torus. Other languages may use other indications of character areas, etc. Dividable character components are larger (e.g., more complex) character components that can be further segmented by the separators. The standard component model 360 can group components with enough visual similarity into clusters, such that components in the same cluster can be replaced by each other through a series of similarity transformations when constructing certain character(s).

Sample character template generation 364 occurs based on the character construction model 362, the character segmentation model 358, and the standard component model 360. A subset of characters 368 embodying some or all of the character components can be selected 366 from the desired resultant (e.g., pre-defined) character set based on the three character component organization models. The subset of characters is chosen such that the character components in the chosen sample characters can be used to construct the balance of characters in the character set.

According to some embodiments, this can be a scalable process. That is, the desired output character set may include less than all possible characters of a language. For example, a desired output character set may include only 90% of the possible characters, such as those most often used. Therefore, a desired output set may not include 10% of the possible characters, such as those that are obscure and/or seldom used in common and/or modern communications. By excluding the least common 10% of possible characters, the sample set that includes all the necessary character components may be reduced by one-half, for example, where the excluded characters utilize many character components unique to a small number of characters.

Once the subset of characters needed to contain the necessary character components is identified, template generation 370 can occur. Template generation generates a template 372 to indicate to a user the sample characters 368 to be handwritten. According to at least one example embodiment, a template with grids and selected sample characters is generated for printing out. The template indicates those characters that a user is to write by hand, and can provide a space in which to write each sample character.

According to some embodiments, the user writes down the requested sample characters on the template 374. Alternatively, the user can write the characters in other media suitable for digitizing and/or conversion to digital format such as onto a tablet computing device or touch-sensitive handwriting pad for example. The template can be scanned 376 into a computing system, such as that illustrated in FIG. 1. By scanning, the (e.g., all) handwritten characters can be converted into character images 388. However, embodiments of this disclosure are not limited to scanning per se. As mentioned, other apparatus and/or methods for inputting handwritten characters as character images (e.g., tablet computing device, touch-screen input device, motion detection input device, etc.) can be used to obtain images of input handwritten characters 388. Obtaining the images of input handwritten characters corresponding to the sample characters of a template can also be referred to a pre-processing.

From the images of input handwritten characters 388, and based on the character segmentation model 358, input handwritten character segmentation 380 can produce a set of handwritten character components, which can be extracted from the input handwritten character images. Then using images of valid handwritten character components 382, and based on the character construction model 362, new handwritten characters (e.g., handwritten characters other than those sample characters the user hand wrote and input) can be constructed 384 by using extracted handwritten character components. New handwritten characters can also include those sample characters directly input by the user (as indicated by the arrow between 388 and 387 in FIG. 3), or the sample characters can be constructed like all other characters, from the character components.

For a variety of reasons, some character components may not be identifiable from the input handwritten character images. For example, the quality of the image may be poor attributable to scanning equipment quality, or the handwriting may be so different from the standardized character construction that a particular handwritten marking may not correspond to a standard character component. A error trapping and re-input process for re-writing characters necessary to obtain certain character components can be used to obtain usable (e.g., valid) images of handwritten character components 382.

The images of new handwritten characters 386 can be mapped to character identification (e.g., numerical codes) used by software and/or otherwise configured to correspond to particular characters in a font library 387. A font library 389 file (e.g., TrueType format) can be generated from images of both input and/or constructed handwritten characters. The generated TrueType font file based on character components of handwritten characters can be installed on an operating system and/or used in other software, such as word processing, printing, editing, displaying, and other character-using applications.

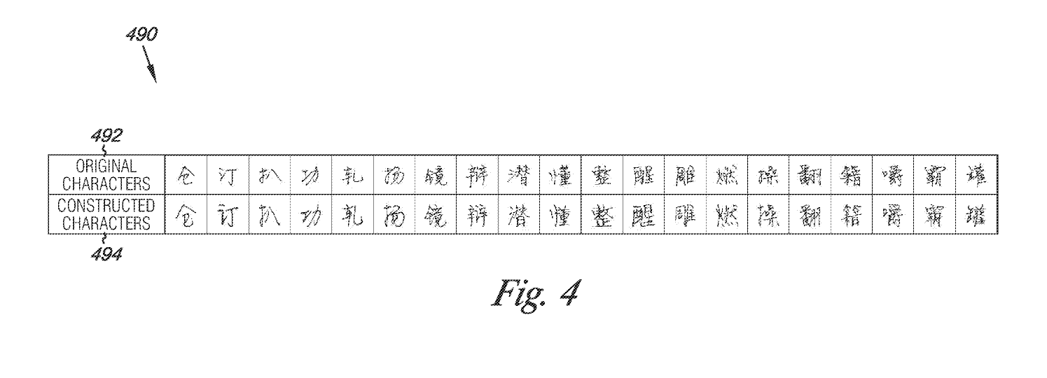

FIG. 4 illustrates a comparison between original and constructed Chinese handwritten characters according to embodiments of the present disclosure. The table 490 shown in FIG. 4 indicates original characters 492 and a corresponding constructed character 494 (e.g., in the user's personal handwriting style).

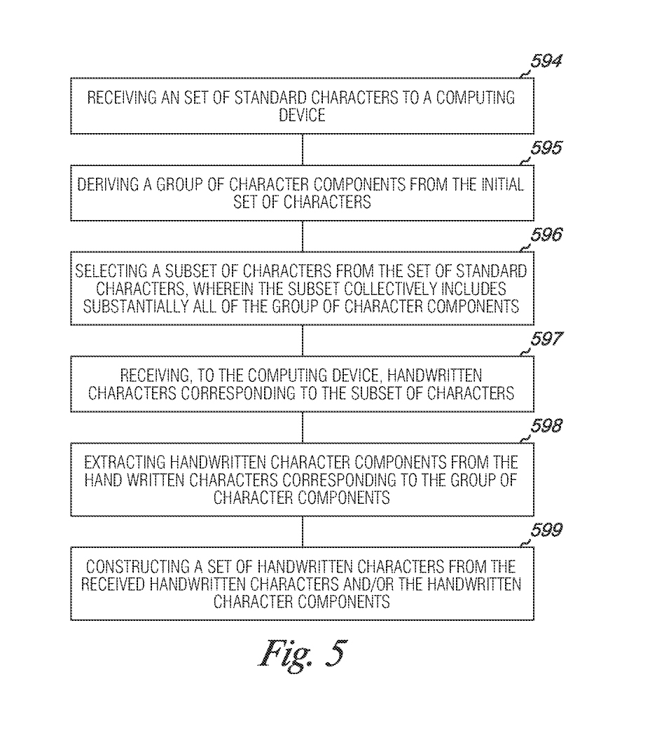

FIG. 5 illustrates a method for creating a handwritten character font library according to embodiments of the present disclosure. The method for creating a handwritten character font library illustrated in FIG. 5 includes receiving 594 a set of standard characters to a computing device, and deriving 595 a group of character components from the initial set of characters. A subset of characters is selected 596 from the set of standard characters, the subset collectively including substantially all of the group of character components. Handwritten characters corresponding to the subset of characters are received 597 to the computing device, and handwritten character components are extracted 598 from the hand written characters corresponding to the group of character components. A set of handwritten characters is then constructed 599 from the received handwritten characters and/or the handwritten character components.

According to various embodiments, a Chinese character component organization model for a simplified Chinese character set with a total of 2,500 characters (which can cover 97.97% characters commonly used in China) can be constructed from character components derived from a total of 522 Chinese characters selected as input sample characters. That is, 522 Chinese characters are directly used and 1,978 characters are constructed using character components extracted from the 522 sample characters, thereby generating a font library (e.g., TrueType) having 2,500 characters. Therefore, it will be appreciated that the methodology of the present disclosure enable a user need only write-out approximately 20% or less of the desired character set to create an applicable Chinese handwritten font library for themselves, thereby significantly reducing the time, cost, and inconvenience as compared to previous approaches of a user writing-out and scanning in each and every character they desire to have in a font library.

According to some embodiments of the present disclosure, less than 500 sample characters can be used to derive the character components for constructing the balance of the GB2312 character set, which has a total of 6,763 characters and covers 99.99% commonly used Chinese characters.

Although specific embodiments have been illustrated and described herein, those of ordinary skill in the relevant art will appreciate that an arrangement calculated to achieve the same techniques can be substituted for the specific embodiments shown. This disclosure is intended to cover all adaptations or variations of various embodiments of the present disclosure. It is to be understood that the above description has been made in an illustrative fashion, and not a restrictive one. Combination of the above embodiments, and other embodiments not specifically described herein, will be apparent to those of ordinary skill in the relevant art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure need to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for creating a handwritten character font library, comprising:
receiving a set of standard characters to a computing device;
deriving a group of character components from the initial set of characters;
selecting a subset of characters from the set of standard characters, wherein the subset collectively includes substantially all of the group of character components;
receiving, to the computing device, handwritten characters corresponding to the subset of characters;
extracting handwritten character components from the hand written characters corresponding to the group of character components; and
constructing a set of handwritten characters from the received handwritten characters and/or the handwritten character components.

2. The method of claim 1, wherein the character components are unique irrespective of size and/or location within a character, and are unconnected from one another.

3. The method of claim 1, further comprising generating a template of sample characters to indicate to a user the handwritten characters to be received.

4. The method of claim 1, wherein subset of characters only includes a minimum quantity of characters from the set of standard characters that collectively includes all the group of character components.

5. The method of claim 1, wherein a quantity of characters included in the subset of characters is approximately 20% or less of the characters included in the set of standard characters.

6. The method of claim 1, wherein there is a one-to-one correspondence between the characters of the set of handwritten characters and the characters of the set of standard characters.

7. The method of claim 1, wherein constructing a set of handwritten characters includes merging character components level by level to form a character component segmentation hierarchy according to predefined heuristic rules.

8. The method of claim 1, further comprising storing an organization hierarchy of all character components with their relative size and position associated with each character of the set of standard characters.

9. The method of claim 1, further comprising grouping visually similar character components into clusters, such that character components in a same cluster can be replaced by each other through a series of similarity transformations when constructing a particular character.

10. The method of claim 1, further comprising storing the position of separators between dividable character components associated with a particular character.

11. The method of claim 1, wherein the set of standard characters are Chinese characters.

12. The method of claim 11, wherein the set of standard characters is the GB2312 character set.

13. The method of claim 1, wherein the set of standard characters is based on the simplified Chinese KaiTi font character set.

14. A non-transitory computer-readable medium having computer-readable instructions stored thereon that, if executed by one or more processors, cause the one or more processors to:
receive a set of standard characters to a computing device;
derive a group of character components from the initial set of characters;
select a subset of characters from the set of standard characters, wherein the subset collectively includes substantially all of the group of character components;
receive, to the computing device, handwritten characters corresponding to the subset of characters;
extract handwritten character components from the hand written characters corresponding to the group of character components; and
construct a set of handwritten characters from the received handwritten characters and/or the handwritten character components.

15. A computing system, comprising:
a computing device having at least one processor;
a production device communicatively coupled to the computing device; and
a non-transitory computer-readable medium having computer-readable instructions stored thereon that, if executed by the at least one processor, cause the at least one processor to:
receive a set of standard characters to a computing device;
derive a group of character components from the initial set of characters;
select a subset of characters from the set of standard characters, wherein the subset collectively includes substantially all of the group of character components;
receive, to the computing device, handwritten characters corresponding to the subset of characters;
extract handwritten character components from the hand written characters corresponding to the group of character components; and
construct a set of handwritten characters from the received handwritten characters and/or the handwritten character components.
